(19) United States
(12) Patent Application Publication
(10) Pub. No.: US 2024/0025190 A1
(43) Pub. Date: Jan. 25, 2024

(54) CONVEYANCE DEVICE, IMAGE FORMING APPARATUS, AND LIQUID DISCHARGE APPARATUS

(71) Applicant: Tatsuhiro OHNO, Kanagawa (JP)

(72) Inventor: Tatsuhiro OHNO, Kanagawa (JP)

(21) Appl. No.: 18/224,076

(22) Filed: Jul. 20, 2023

(30) Foreign Application Priority Data
Jul. 25, 2022 (JP) 2022-117703

(51) Int. Cl. B41J 11/00

(52) U.S. Cl. CPC B41J 11/007; B41J 11/0095

(57) ABSTRACT

A conveyance device includes a conveyor, a position sensor, and a background member. The conveyor conveys a medium. The position sensor detects a position of the medium conveyed by the conveyor. The background member faces the position sensor. The background member is insertable and removable in a width direction of the medium crossing a conveyance direction of the medium.

### CROSS-REFERENCE TO RELATED APPLICATION

This patent application is based on and claims priority pursuant to 35 U.S.C. § 119(a) to Japanese Patent Application No. 2022-117703, filed on Jul. 25, 2022, in the Japan Patent Office, the entire disclosure of which is hereby incorporated by reference herein.

### BACKGROUND

### Technical Field

Embodiments of the present disclosure relate to a conveyance device, an image forming apparatus, and a liquid discharge apparatus.

### Related Art

Inkjet recording apparatuses are known to include a belt conveyance unit, a recording unit, an end position detection sensor, a background member, and a rotation drive unit. The belt conveyance unit includes a conveyance belt to convey a recording medium. The recording unit is disposed opposite the belt conveyance unit to discharge ink onto the recording medium conveyed by the belt conveyance unit. The end position detection sensor is disposed upstream from the belt conveyance unit in a recording-medium conveyance direction to detect an end position of the recording medium in a recording-medium width direction crossing the recording-medium conveyance direction using reflected light. The background member is disposed opposite a detection surface of the end position detection sensor and rotatable about an axis extending along the recording-medium width direction. The rotation drive unit rotates the background member.

### SUMMARY

Embodiments of the present disclosure described herein provide a novel conveyance device including a conveyor, a position sensor, and a background member. The conveyor conveys a medium. The position sensor detects a position of the medium conveyed by the conveyor. The background member faces the position sensor. The background member is insertable and removable in a width direction of the medium crossing a conveyance direction of the medium.

Embodiments of the present disclosure described herein provide a novel image forming apparatus including the conveyance device and an image forming device. The image forming device forms an image on the medium conveyed by the conveyance device.

Embodiments of the present disclosure described herein provide a novel liquid discharge apparatus including the conveyance device described above and a liquid discharger. The liquid discharger discharges liquid to the medium conveyed by the conveyance device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a schematic diagram of an image forming unit according to an embodiment of the present disclosure;

FIG. 3 is a schematic plan view of a pair of registration rollers and illustrates the shift operation of the pair of registration rollers, according to an embodiment of the present disclosure;

FIG. 4 is a schematic diagram of an image sensor and elements around the image sensor, according to an embodiment of the present disclosure;

FIG. 5 is a perspective view of an image sensor and elements around the image sensor, according to an embodiment of the present disclosure:

FIG. 6 is a perspective view of an attachment base to which a holder is attached, according to an embodiment of the present disclosure;

FIG. 7 is a perspective view of the attachment base of FIG. 6;

FIG. 8 is a perspective view of the holder of FIG. 6:

FIGS. 9A and 9B are perspective views of a pressing member according to an embodiment of the present disclosure;

FIGS. 10A and 10B are diagrams illustrating a pressing member and a positioning member according to an embodiment of the present disclosure:

FIG. 11 is a diagram illustrating implementation of the holder according to an embodiment of the present disclosure:

FIG. 12 is a diagram illustrating an attaching sensor according to an embodiment of the present disclosure;

FIG. 13 is a diagram illustrating an overall configuration of an inkjet image forming apparatus according to an embodiment of the present disclosure, and

FIGS. 14A and 14B are diagrams each illustrating an overall configuration of a liquid discharge apparatus according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an image forming apparatus according to an embodiment of the present disclosure with reference to the drawings.

In the description of the drawings, the same elements are denoted by the same reference numerals, and redundant descriptions thereof are omitted.

Configuration of Image Forming Apparatus

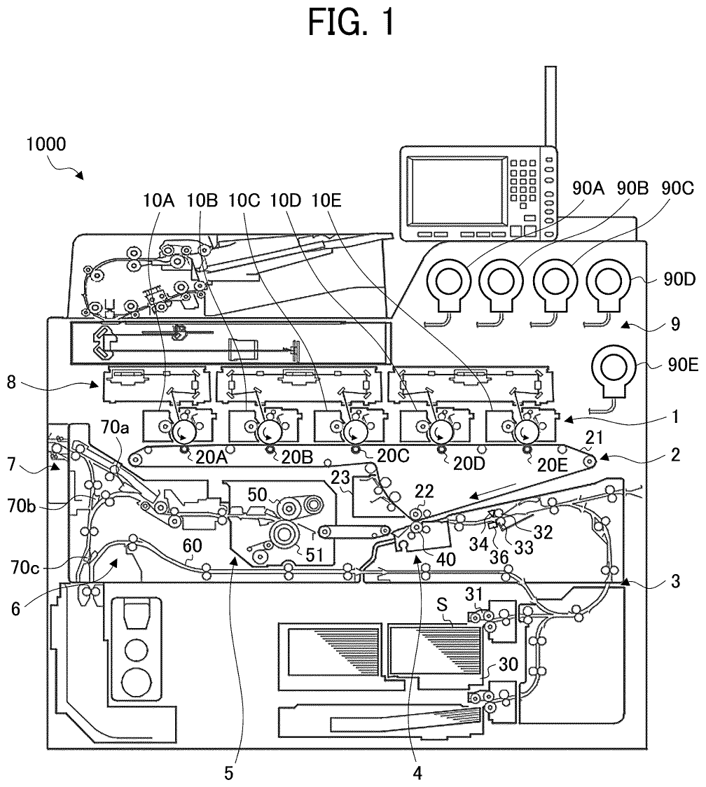

FIG. 1 is a diagram illustrating an overall configuration of an image forming apparatus according to an embodiment of the present disclosure.

The image forming apparatus illustrated in FIG. 1 is a printer that performs image formation by an electrophotographic method.

A printer 1000 includes an image forming device 1, a primary transfer device 2, a sheet supply device 3, a secondary transfer device 4, a fixing device 5, a sheet returning device 6, a sheet ejecting device 7, an exposure device 8, and a toner container mounting device 9.

The image forming device 1, the primary transfer device 2, the secondary transfer device 4, and the exposure device 8 together configure an image former.

The image forming device 1 includes a plurality of image forming units, which are five image forming units 10A, 10B, 10C, 10D, and 10E in the present embodiment.

The multiple image forming units may be collectively referred to as an image forming unit(s) 10 in the following description.

The image forming units 10A to 10E respectively form toner images of different colors.

For example, the image forming unit 10B forms a yellow (Y) toner image, the image forming unit 10C forms a magenta (M) toner image, and the image forming unit 10D forms a cyan (C) toner image.

The image forming unit 10E forms a black (K) toner image, and the image forming unit 10A forms a toner image of a special color other than Y, M, C, and K.

The special color is not limited to a colored color and may include a colorless color such as a clear toner.

The number of the image forming units 10 and the arrangement order of the colors are not limited to the above description.

The number of image forming units 10 may be four or less, or six or more.

The order in which the colors of the image forming units are arranged may be appropriately determined in accordance with the specifications of the image forming units and toner characteristics.

The image forming unit 10 include a photoconductor module, a charging module, a developing module, and a cleaning module.

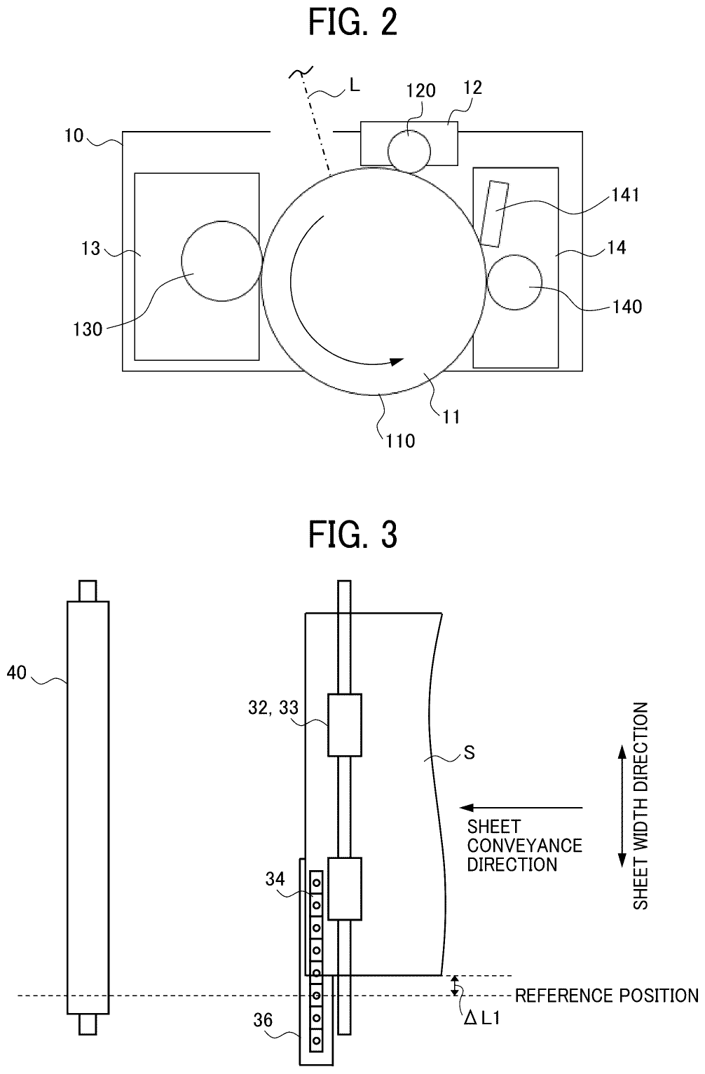

These multiple modules are described with reference to FIG. 2.

FIG. 2 is a schematic diagram of the image forming unit 10 according to an embodiment of the present disclosure.

Since the image forming units 10A to 10E have substantially the same configuration, the image forming units 10A to 10E are illustrated as the image forming unit 10 in FIG. 2.

The image forming unit 10 includes a photoconductor module 11, a charging module 12, a developing module 13, and a cleaning module 14.

The photoconductor module 11 includes, for example, a cylindrical photoconductor 110.

The photoconductor 110 is driven to rotate in a counterclockwise (arrow direction) in FIG. 2.

The charging module 12 includes, for example, a charging roller 120.

The charging roller 120 applies an electric charge to the surface of the photoconductor 110 to charge the surface of the photoconductor 110 to a predetermined potential.

The developing module 13 includes, for example, a developing roller 130 that includes a two-component developer containing a toner and a magnetic carrier.

The exposure device 8, which is described later, exposes the surface of the photoconductor 110, which has been charged to the predetermined potential, with light. The developing roller 130 applies toner to the electrostatic latent image to form a toner image on the surface of the photoconductor 110.

The cleaning module 14 includes a cleaner such as a cleaning roller 140 and a cleaning blade 141.

The cleaning roller 140 and the cleaning blade 141 clean the surface of the photoconductor 110 that has passed the primary transfer device 2 described later.

Returning to FIG. 1, an overall configuration of the printer 1000 is described.

The primary transfer device 2 is disposed below the image forming device 1.

The primary transfer device 2 includes multiple primary transfer rollers 20A, 20B, 20C, 20D, and 20E, an intermediate transfer belt 21, a secondary transfer opposing roller 22, and a belt cleaner 23.

The multiple primary transfer rollers may be collectively referred to as a primary transfer roller(s) 20 in the following description.

The multiple primary transfer rollers 20 are disposed at positions facing the multiple photoconductors 110 of the image forming unit 10, respectively.

The primary transfer rollers 20 are disposed such that the primary transfer rollers 20 can press the photoconductors 110 via the intermediate transfer belt 21. The primary transfer roller 20 is pressed toward the photoconductor 110 to form a primary transfer nip between the photoconductor 110 and the intermediate transfer belt 21.

A primary transfer bias is applied to the primary transfer roller 20 to form a primary transfer electric field in the primary transfer nip.

The intermediate transfer belt 21 is an endless belt formed in a single layer or multiple layers of, polyvinylidene fluoride (PVDF), ethylene-tetrafluoroethylene copolymer (ETFE), polyimide (PI), or polycarbonate (PC).

The intermediate transfer belt 21 is stretched over multiple support rollers and moves in a clockwise direction in FIG. 1.

The secondary transfer opposing roller 22 forms a secondary transfer nip together with a secondary transfer roller 40 included in the secondary transfer device 4 described later.

The belt cleaner 23 cleans the surface of the intermediate transfer belt 21 that has passed the secondary transfer roller 40 (secondary transfer nip) described later.

The sheet supply device 3 is disposed in a lower portion of the printer 1000.

The sheet supply device 3 includes a sheet tray 30, a sheet feeder 31, and a pair of registration rollers 32 and 33, an image sensor 34, and a background member 36. The sheet tray 30 loads sheets S. The sheet feeder 31 feeds the sheets S one by one from the sheet tray 30. The pair of registration rollers 32 and 33 convey the sheet S fed from the feeder 31 to the secondary transfer device 4 at a predetermined timing.

The sheet supply device 3 according to the present embodiment serves as a conveyance device. The pair of registration rollers 32 and 33 according to the present embodiment serves as a conveyor. The sheet S according to the present embodiment serves as a medium. The image sensor 34 according to the present embodiment serves as a position sensor.

Details of the background member 36 are described in detail later.

Although the configurations of the pair of registration rollers 32 and 33 and the image sensor 34 are described below, as a summary, the pair of registration rollers 32 and 33 can perform a shift operation in a main scanning direction (a sheet width direction crossing a sheet conveyance direction).

The image sensor 34 measures the position in the main scanning direction of the sheet S conveyed by the pair of registration rollers 32 and 33.

When the sheet S is conveyed at a position deviated from the reference position, the pair of registration rollers 32 and 33 is shifted in a direction to eliminate the deviation in a state where the pair of registration rollers 32 and 33 nips the sheet S at the nip, and the sheet S is aligned with the reference position.

The secondary transfer device 4 is disposed below the primary transfer device 2.

The secondary transfer device 4 includes a secondary transfer roller 40.

The secondary transfer roller 40 is disposed at a position facing the secondary transfer opposing roller 22 included in the primary transfer device 2 and is disposed such that the secondary transfer roller 40 presses the secondary transfer opposing roller 22 via the intermediate transfer belt 21.

The secondary transfer roller 40 is pressed against the secondary transfer opposing roller 22 to form the secondary transfer nip between the secondary transfer roller 40 and the intermediate transfer belt 21.

A secondary transfer bias is applied to the secondary transfer roller 40 to form a secondary transfer electric field in the secondary transfer nip.

The fixing device 5 is disposed downstream from the secondary transfer device 4 in a sheet conveyance direction (on the left side in FIG. 1).

The fixing device 5 includes a heat roller 50 and a pressure roller 51.

The heat roller 50 and the pressure roller 51 can be pressed against each other to form a fixing nip between the heat roller 50 and the pressure roller 51.

The sheet S to which the toner image is transferred at the secondary transfer device 4 is heated and pressed at the fixing nip. As a result, the toner image is fixed on the sheet S.

The sheet ejecting device 7 is disposed downstream from the fixing device 5 in the sheet conveyance direction (on the left side in FIG. 1).

The sheet ejecting device 7 includes switchers 70 (70a, 70b, and 70c) that switch the eject destination of the sheet S. and the switchers 70 convey the sheet S to the outside of the printer 1000 or to the sheet returning device 6 described later.

The sheet returning device 6 is disposed below the sheet ejecting device 7, the fixing device 5, and the secondary transfer device 4.

The sheet returning device 6 includes a return path 60 having multiple conveyance rollers.

The end point of the return path 60 merges with the sheet supply device 3 and conveys the sheet S conveyed from the sheet ejecting device 7 toward the secondary transfer device 4 again.

The exposure device 8 is disposed above the image forming device 1.

The exposure device 8 scans the photoconductor 110, which has been charged to the predetermined potential by the charging module 12, with a laser beam L (see FIG. 2) to form an electrostatic latent image on the surface of the photoconductor 110.

The toner container mounting device 9 is disposed above the exposure device 8.

The toner container mounting device 9 detachably holds toner containers 90A, 90B, 90C, 90D, and 90E containing toner used in the image forming units 10A, 10B, 10C, 10D, and 10E, respectively.

The toner container mounting device 9 and the image forming device 1 are coupled to each other by a toner transfer mechanism, and the multiple kinds of toner that are contained in the toner containers 90A to 90E are transferred to the image forming units 10A to 10E, respectively, by the toner transfer mechanism.

When any one of the toner containers 90A to 90E is to be replaced, the toner container is removed from the toner container mounting device 9 and replaced with a new toner container.

When the printer 1000 receives image data transmitted from an external device such as a personal computer, the printer 1000 starts a print job and starts driving the intermediate transfer belt 21.

Then, in the image forming device 1, the charging roller 120 evenly charges the surface of the rotating photoconductor 110 to a predetermined charging potential.

The electrostatic latent image of each color is formed on the charged surface of the photoconductor 110 by optical scanning using laser light emitted by the exposure device 8 based on image data.

The developing modules 13 of the image forming units 10A to 10E develop the electrostatic latent images into toner images. Then, the toner images of the image forming units 10A to 10E are sequentially transferred onto the intermediate transfer belt 21 such that the toner images of multiple colors are superimposed on top of one another on the surface of the intermediate transfer belt 21 in a primary transfer process. As a result, the toner image is formed on the intermediate transfer belt 21.

After the toner image is transferred to the intermediate transfer belt 21, the cleaning module 14 cleans the photoconductor 110 to remove the toner remaining on the surface of the photoconductor 110 from the surface of the photoconductor 110.

The sheet S fed from the sheet feeder 31 of the sheet supply device 3 is conveyed until the sheet S reaches the pair of registration rollers 32 and 33. When the sheet S reaches the pair of registration rollers 32 and 33, the conveyance of the sheet S is temporarily stopped.

Then, the pair of registration rollers 32 and 33 starts conveying the sheet S again in synchronization with movement of the toner image on the intermediate transfer belt 21 reaching the secondary transfer nip.

The sheet S, which is conveyed again by the pair of registration rollers 32 and 33, meets the toner image on the intermediate transfer belt 21 in the secondary transfer nip. Thus, in synchronization with movement of the toner image on the intermediate transfer belt 21, the toner image is transferred from the intermediate transfer belt 21 onto the sheet S in the secondary transfer nip.

After the toner image has been transferred onto the sheet S in the secondary transfer nip, the sheet S is conveyed to the fixing device 5 where the toner image on the sheet S is fixed to the sheet S by application of heat and pressure.

After that, the sheet S is conveyed to the sheet ejecting device 7, and then the sheet S is conveyed to the outside of the printer 1000 or to the sheet returning device 6 according to the guide of the switchers 70.

The sheet returning device 6 reverses the sheet S upside down (front and back sides) to convey the sheet S again to the secondary transfer nip. The sheet S is ejected from the sheet ejecting device 7 after the toner image is secondarily transferred to the back side of the sheet S at the secondary transfer nip.

After the intermediate transfer belt 21 passes through the secondary transfer nip, the belt cleaner 23 cleans the intermediate transfer belt 21 to remove toner remaining on the surface of the intermediate transfer belt 21 from the surface of the intermediate transfer belt 21.

Configuration of Pair of Registration Rollers

FIG. 3 is a schematic plan view of the pair of registration rollers 32 and 33 and illustrates the shift operation of the pair of registration rollers 32 and 33, according to an embodiment of the present disclosure.

As described above, the pair of registration rollers 32 and 33 can perform the shift operation to shift the sheet S in a main scanning direction (sheet width direction) while nipping the sheet S.

For example, a contact image sensor (CIS) is used as the image sensor 34, and the image sensor 34 measures the position in the main scanning direction of the sheet S conveyed by the pair of registration rollers 32 and 33.

In other words, the image sensor 34 detects whether an edge of the sheet S in the width direction is being conveyed along a reference position.

The background member 36 is disposed at a position facing the image sensor 34.

Details of the background member 36 are described in detail later.

When the sheet S is being conveyed at a position away from the reference position by ΔL1, the pair of registration rollers 32 and 33 is shifted by ΔL1 to correct the position such that the edge of the sheet S fits to the reference position.

The sheet S is conveyed toward the secondary transfer roller 40 while the above-described position correction is performed on the sheet S.

As a result, the toner image can be transferred to a correct position on the sheet S. In the present embodiment, the image sensor 34 is disposed near and downstream from the pair of registration rollers 32 and 33 in the sheet conveyance direction. However, the image sensor 34 may be disposed near and upstream from the pair of registration rollers 32 and 33 in the sheet conveyance direction.

The image sensor 34 may be disposed not only at one position but also at two or more positions in the sheet conveyance direction, and the pair of registration rollers 32 and 33 may be shifted based on the output of the multiple image sensors.

Configuration around Image Sensor

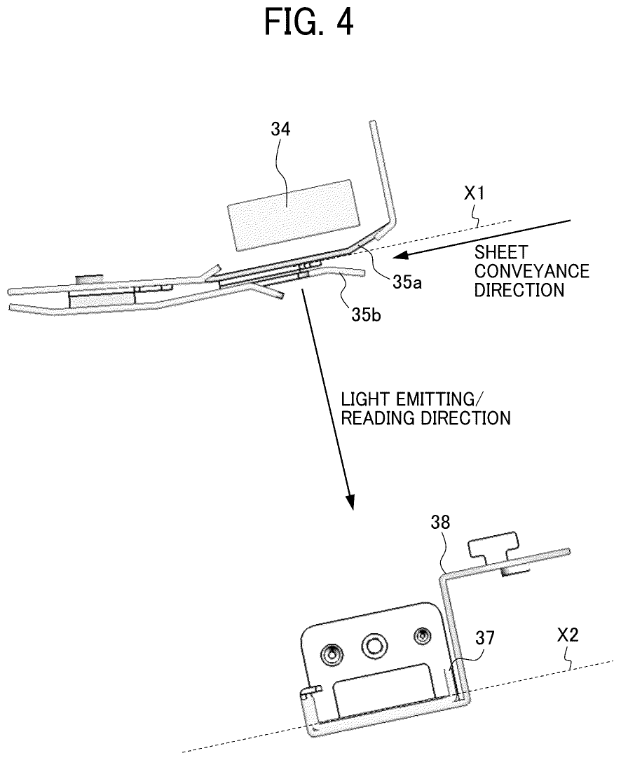

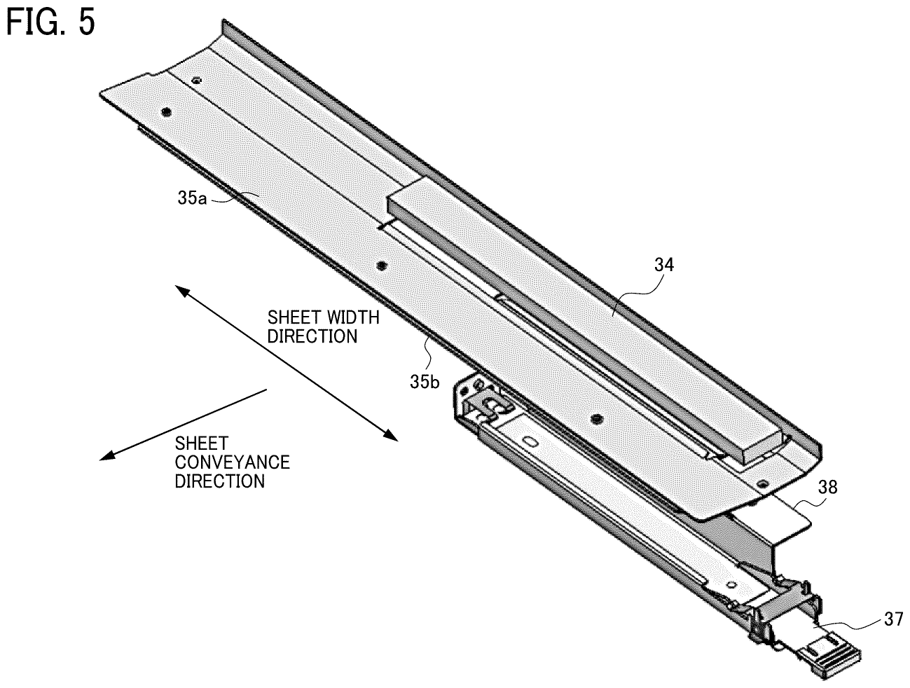

A description is given below of a configuration of the image sensor 34 and elements around the image sensor 34 with reference to FIGS. 4 and 5.

FIG. 4 is a schematic diagram of the image sensor 34 and elements around the image sensor 34, according to an embodiment of the present disclosure.

FIG. 5 is a perspective view of the image sensor 34 and elements around the image sensor 34, according to an embodiment of the present disclosure.

The pair of registration rollers 32 and 33 conveys the sheet S in the sheet conveyance direction illustrated in FIGS. 4 and 5, and the sheet S is conveyed to the secondary transfer nip via a conveyance passage formed by an upper guide plate 35a and a lower guide plate 35b.

The image sensor 34 is disposed above the upper guide plate 35a such that a sensor surface of the image sensor 34 faces the conveyance passage.

On the other hand, a holder 37 for holding the background member 36, which is described later, is disposed below the lower guide plate 35b.

The holder 37 is attached to an attachment base 38. The attachment base 38 is fixed to a housing frame or a side plate of the printer 1000.

Accordingly, the holder 37 is fixed to a predetermined position via the attachment base 38.

When it is assumed that an imaginary line parallel to a guide surface of the upper guide plate 35a is X1 and an imaginary line parallel to a holding surface of the holder 37 is X2, the predetermined position is a position where the imaginary line X1 and the imaginary line X2 are substantially parallel to each other and a light emitting and reading direction of the image sensor 34 and the imaginary line X2 are substantially orthogonal to each other.

Note that the predetermined position is not limited to the above-described positional relation and may be appropriately changed as long as the predetermined position is within a range that does not deviate from the light emitting and reading direction of the image sensor 34.

Configurations of Attachment Base and Holder

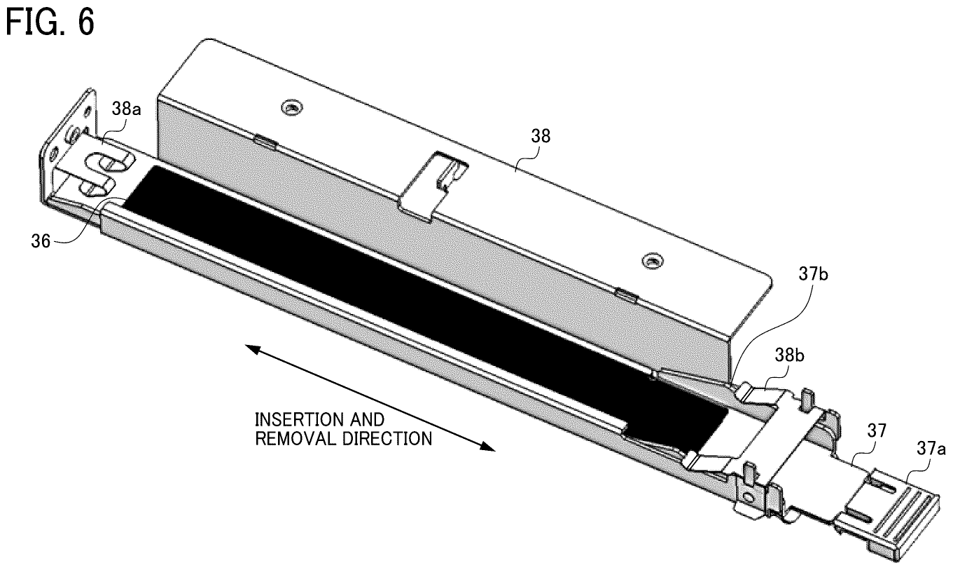

A description is given below of the configuration of the attachment base 38 and the holder 37 with reference to FIGS. 6 to 12.

FIG. 6 is a perspective view of the attachment base 38 to which the holder 37 is attached, according to an embodiment of the present disclosure.

The holder 37 has a substantially elongated rectangular shape and is supported by the attachment base 38 such that the holder 37 is movable in insertion and removal directions with respect to the attachment base 38 in arrow illustrated in FIG. 6.

The holder 37 includes the background member 36 made of a sheet material that prevents reflection of light from the image sensor 34. The background member 36 is disposed on an upper surface of the holder 37 (the upper surface faces the image sensor 34).

The holder 37 includes a handle 37a and positioning members 37b.

The handle 37a is disposed at one end of the holder 37 in the longitudinal direction of the holder 37. When an operator grips the handle 37a and then pull the handle 37a, the holder 37 is pulled and removed from the attachment base 38.

The positioning members 37b are disposed at both ends in the lateral direction of the holder 37. A pressing member 38b of the attachment base 38 engages the positioning members 37b to position the holder 37 with respect to the attachment base 38.

The attachment base 38 includes a pressing member 38a and the pressing member 38b.

The pressing member 38a is disposed in the attachment base 38 such that the pressing member 38a can contact the side surface (the upper surface of the holder 37 in the present embodiment) on the back side (the side opposite to the handle 37a) of the holder 37.

The pressing member 38b is disposed in the attachment base 38 such that the pressing member 38b can be engageable with the positioning members 37b disposed on the front side (the side having the handle 37a) of the holder 37.

As described above, in the present embodiment, the sheet supply device 3 includes the pair of registration rollers 32 and 33 to convey the sheet S, the image sensor 34 to detect the position of the conveyed sheet S, and the background member 36 disposed to face the image sensor 34. The background member 36 can be inserted and removed in the width direction of the sheet S crossing the conveyance direction of the sheet S.

As described above, the printer 1000 includes the holder 37 to hold the background member 36 and the attachment base 38 on which the holder 37 is attached such that the holder 37 can be inserted and removed in the width direction of the sheet S.

Accordingly, the background member 36 facing the image sensor 34 can be removed from the printer 1000. When a foreign substance, such as paper dust in the case where the sheet S is a sheet of paper, adheres to the background member 36, the background member 36 can be cleaned.

As a result, a false detection of the image sensor 34 caused by adhesion of the foreign substance to the background member 36 can be reduced.

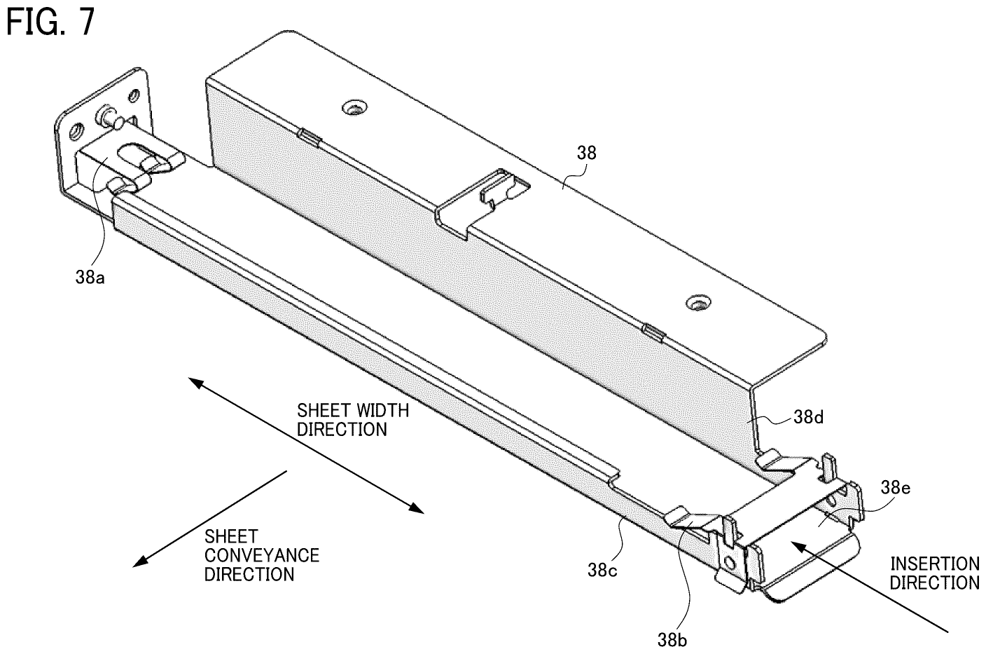

FIG. 7 is a perspective view of the attachment base 38 according to an embodiment of the present disclosure.

The attachment base 38 is a member fixed to the housing frame or the side plate of the printer 1000.

In the attachment base 38, the pressing member 38b is supported across a sidewall 38c and a sidewall 38d, and an opening 38e is formed below the pressing member 38b.

When the holder 37 is inserted from the opening 38e in the insertion direction described in FIG. 7, the holder 37 is attached to the attachment base 38 as illustrated in FIG. 6.

The sidewalls 38c and 38d according to the present embodiment serve as a first restraint.

When the holder 37 is attached to the attachment base 38, the sidewalls 38c and 38d restrict the position of the holder 37 such that the holder 37 is not displaced in the sheet conveyance direction.

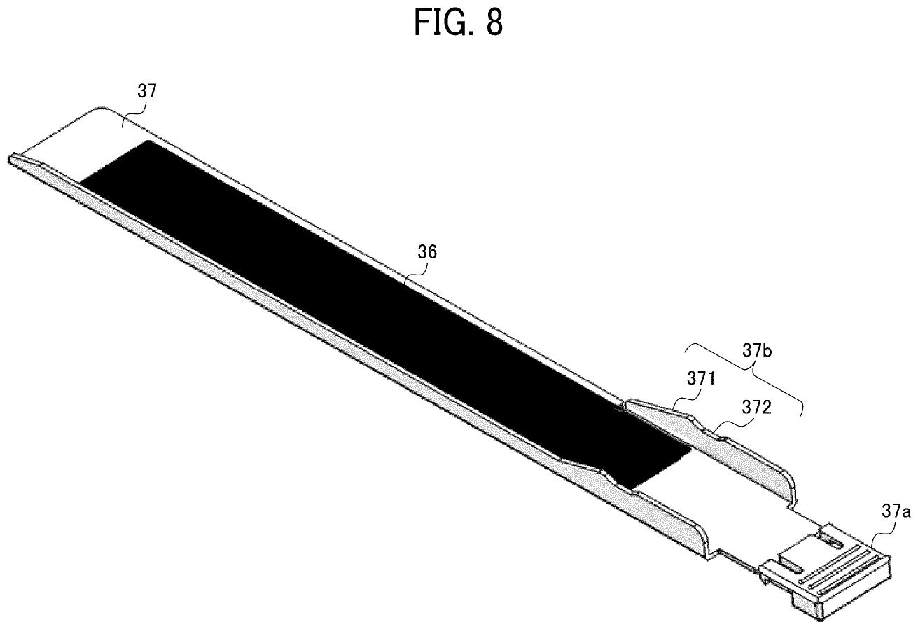

FIG. 8 is a perspective view of the holder 37 according to an embodiment of the present disclosure.

As described above, the holder 37 includes the background member 36, the handle 37a, and the positioning member 37b.

The positioning member 37b have an outer shape in which a slope 371 and a recess 372 are continuously formed.

When the holder 37 is inserted from the opening 38e described above and attached to the attachment base 38, the pressing member 38b contacts with the slope 371 and the recess 372 in this order, and the holder 37 is positioned where the pressing member 38b is engaged with the recess 372.

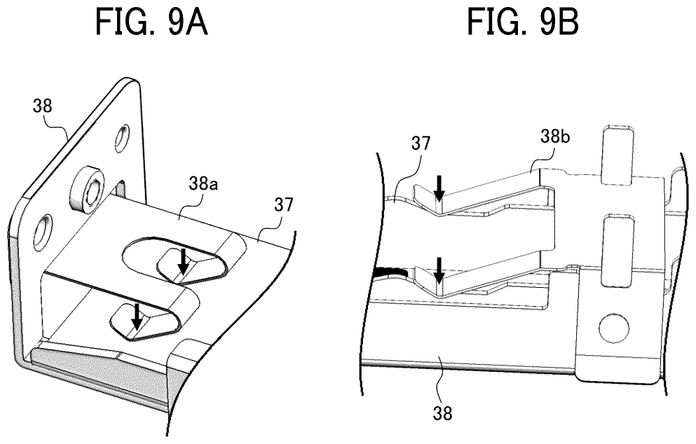

FIGS. 9A and 9B are perspective views of the pressing members 38a and 38b, respectively, according to an embodiment of the present disclosure.

FIG. 9A illustrates a configuration of the pressing member 38a disposed on the back side of the attachment base 38.

FIG. 9B illustrates a configuration of the pressing member 38b disposed on the front side of the attachment base 38.

The pressing members 38a and 38b are made of plate springs that serve as elastic members.

When the holder 37 is attached to the attachment base 38, the pressing members 38a and 38b press the holder 37 in the directions of arrows illustrated in FIGS. 9A and 9B to prevent the holder 37 from leaving from the attachment base 38.

The pressing members 38a and 38b according to the present embodiment serve as a second restraint. When the holder 37 is attached to the attachment base 38, the pressing members 38a and 38b restrict the position of the holder 37 such that the holder 37 is not displaced in the sheet width direction.

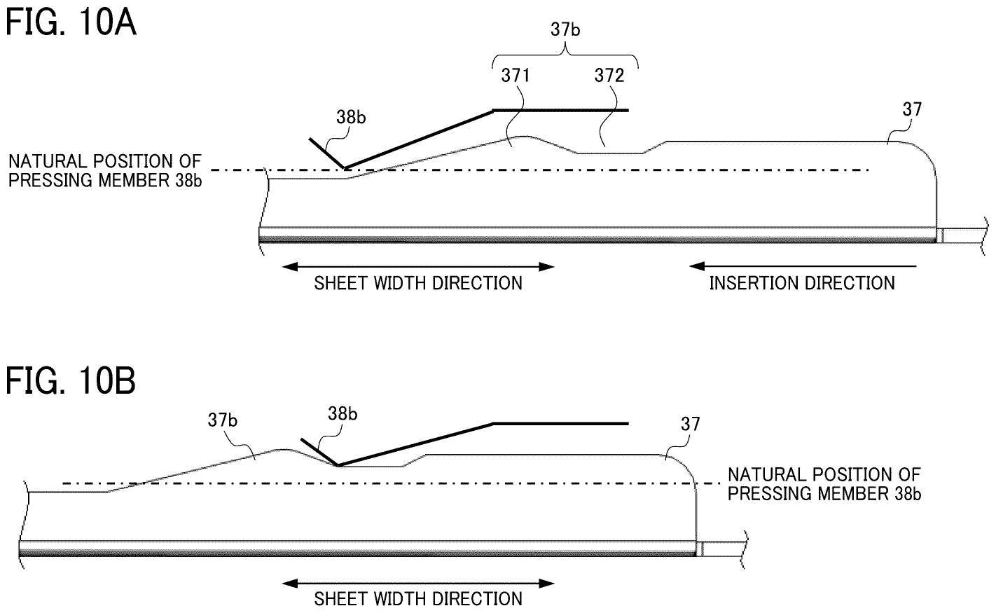

FIGS. 10A and 10B are diagrams illustrating the pressing member 38b and the positioning member 37b according to an embodiment of the present disclosure. FIG. 10A illustrates the holder 37 during attachment. FIG. 10B illustrates the holder 37 at completion of the attachment.

The positioning member 37b of the holder 37 includes the slope 371 and the recess 372.

The heights of the slope 371 and the recess 372 are set at positions higher than a natural position of the pressing member 38b, which is the position of the plate spring of the pressing member 38b when external force is not applied to the pressing member 38b. The natural position of the pressing member 38b is indicated by the dash-single-dot line in FIGS. 10A and 10B.

When the holder 37 is attached to the attachment base 38, the slope 371 and the recess 372 act in a direction of pushing up the pressing member 38b. Accordingly, the holder 37 can be pressed against the attachment base 38 by a reaction force.

The slope 371 includes a slope portion ascending from left to right as illustrated in FIG. 10A and then a slope portion descending from left to right illustrated in FIG. 10A.

The recess 372 is set to a height that is lower than the highest point of the slope 371 (a point where the slope 571 changes from the ascending slope portion to the descending slope portion) and that is the same as the height of a contact surface of the pressing member 38b when the holder 37 is attached to the attachment base 38.

Since the holder 37 has the slope 371, the holder 37 can prevent a sharp increase in load when the holder 37 pushes up the pressing member 38b, and the holder 37 can reduce the load of the operator when the operator inserts and removes the holder 37.

Since the height of the recess 372 is set as described above, the pressing member 38b is properly caught by the recess 372. Accordingly, the holder 37 can be prevented from coming out due to, for example, vibration.

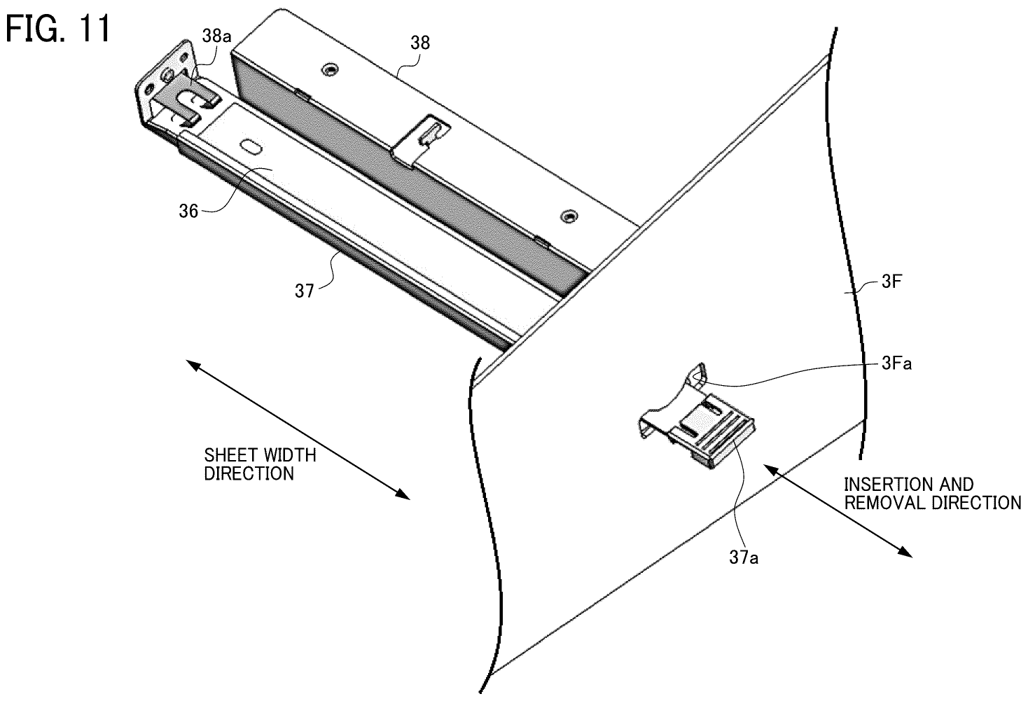

FIG. 11 is a diagram illustrating implementation of the holder 37 according to an embodiment of the present disclosure.

The attachment base 38 is fixed to, for example, a side plate 3F of the sheet supply device 3.

The side plate 3F includes a mounting port 3Fa facing the opening 38e of the attachment base 38.

As a result, the operator can access the handle 37a exposed from the mounting port 3Fa to insert and remove the holder 37 into and from the sheet supply device 3.

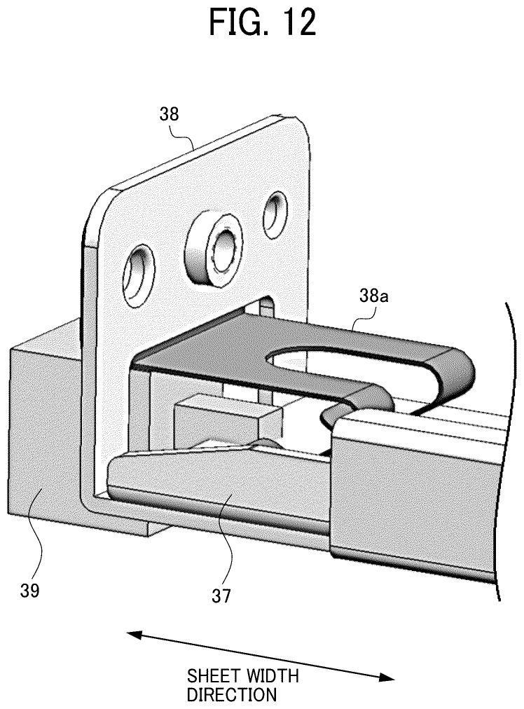

FIG. 12 is a diagram illustrating an attaching sensor 39 according to an embodiment of the present disclosure.

The attachment base 38 may be configured to include the attaching sensor 39 that detects the presence or absence of the holder 37 and detects whether the holder 37 is attached to the attachment base 38.

The attaching sensor 39, for example, outputs an ON-signal when the holder 37 is inserted to a correct position with respect to the attachment base 38 and notifies the operator of an abnormality via an operation device of the printer 1000 when the ON-signal is not output.

As a result, the printer 1000 can prevent the holder 37 from being left uninserted and prevent an image quality failure and a sheet conveyance failure due to the holder 37 being left uninserted.

Application to Other Apparatuses

The image forming apparatus is not limited to an electrophotographic printer as described above, and may be, for example, an inkjet printer.

A description is given below of such an image forming apparatus that serves as an inkjet printer.

Inkjet Printer

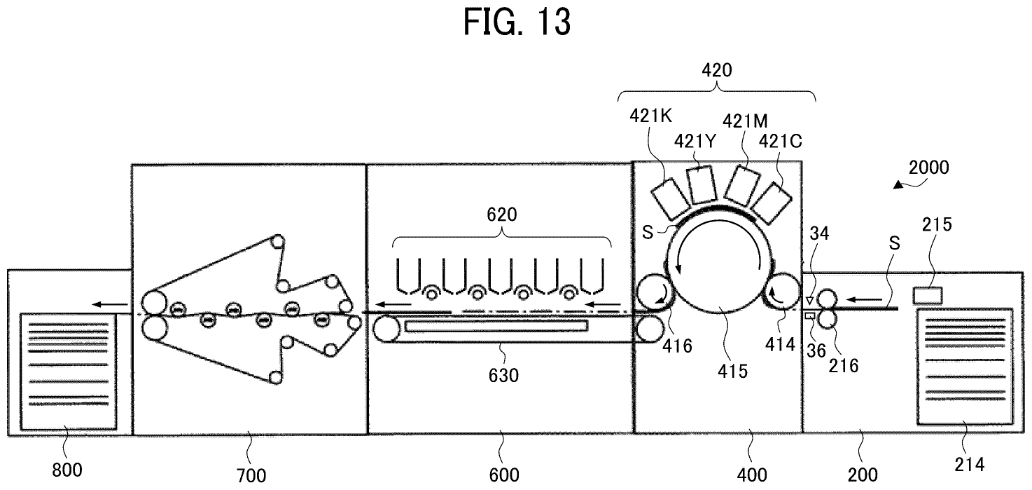

FIG. 13 is a diagram illustrating an overall configuration of an inkjet image forming apparatus according to an embodiment of the present disclosure.

A printer 2000 includes a supply device 200, a printing device 400, a drying device 600, a correcting device 700, and an ejecting device 800.

In the printer 2000, the printing device 400 applies ink that serves as liquid to a sheet S supplied from the supply device 200 to perform desired printing, and the drying device 600 dries the ink applied to the sheet S.

Then, the sheet S is ejected to the ejecting device 800 after the correcting device 700 has corrected a deformation of the sheet S such as a wave or a wrinkle.

The supply device 200 includes a sheet feed tray 214 on which multiple sheets S are stacked, a sheet feeder 215 that separates and feeds the sheets S one by one from the sheet feed tray 214, a pair of registration rollers 216 that conveys the sheet S to the printing device 400, an image sensor 34, and a background member 36.

The supply device 200 serves as a conveyance device, and the pair of registration rollers 216 serves as a conveyor.

The sheet S serves as a medium, and the image sensor 34 serves as a position sensor.

The sheet feeder 215 sends out the sheet S from the sheet feed tray 214. After the leading end of the sheet S fed from the sheet feed tray 214 reaches the pair of registration rollers 216, the pair of registration rollers 216 is driven at a predetermined timing to feed the sheet S to the printing device 400.

The pair of registration rollers 216 can perform a shift operation in the main scanning direction (the sheet width direction intersecting the sheet conveyance direction), similarly to the pair of registration rollers 32 and 33 in the above-described embodiment.

The image sensor 34 measures the position in the main scanning direction of the sheet S conveyed by the pair of registration rollers 216.

When the sheet S is conveyed at a position deviated from a reference position, the pair of registration rollers 216 is shifted in a direction to eliminate the deviation in a state where the pair of registration rollers 216 nips the sheet S at the nip, and the sheet S is aligned with the reference position.

The sheet S is conveyed toward the printing device 400 while the above-described position correction is performed on the sheet S.

The printing device 400 includes a sheet conveyor drum 415 and an inkjet unit 420. The sheet conveyor drum 415 bears and conveys the sheet S on an outer circumferential surface of the sheet conveyor drum 415. The inkjet unit 420 discharges liquid onto the sheet S conveyed on the sheet conveyor drum 415.

The printing device 400 includes a conveying-in drum 414 and a conveying-out drum 416. The conveying-in drum 414 receives the fed sheet S and sends the sheet S to the sheet conveyor drum 415. The conveying-out drum 416 sends the sheet S conveyed by the sheet conveyor drum 415 to the drying device 600.

The leading end of the sheet S conveyed from the supply device 200 to the printing device 400 is gripped by a sheet gripper (or grippers) disposed on the surface of the conveying-in drum 414. The sheet gripper grips the leading end of the sheet S and conveys the sheet S as the conveying-in drum 414 rotates.

The sheet S, which is conveyed by the conveying-in drum 414, is transferred to the sheet conveyor drum 415 at a position at which the conveying-in drum 414 faces the sheet conveyor drum 415.

The sheet conveyor drum 415 has a sheet gripper (or grippers) on the surface. The sheet gripper of the sheet conveyor drum 415 grips the leading end of the sheet S and conveys the sheet S as the sheet conveyor drum 415 rotates.

The inkjet unit 420 includes a plurality of inkjet modules 421 along the rotation direction of the sheet conveyor drum 415. Each of the inkjet modules 421 includes a liquid discharge head that applies ink to the surface of the sheet S.

The inkjet unit 420 includes inkjet modules 421C (cyan), 421M (magenta), 421Y (yellow), and 421K (black) for respective color inks of cyan, magenta, yellow, and black and discharges these four inks to form an image on the sheet S.

The inkjet unit 420 serves as a liquid discharger.

The drying device 600 includes a suction conveyor 630 and a dryer 620. The suction conveyor 630 suctions the sheet S, which is conveyed from the printing device 400, to convey the sheet S. The dryer 620 dries the sheet S conveyed by the suction conveyor 630.

After the sheet S conveyed from the printing device 400 is received by the suction conveyor 630, the sheet S is conveyed such that the sheet S passes through the dryer 620. The sheet S is conveyed to the correction unit 700, and then is conveyed from the correcting device 700 to the ejecting device 800.

In an inkjet printer such as the printer 2000 described above, an image sensor 34 according to an embodiment of the present disclosure may be disposed between the pair of registration rollers 216 and the conveying-in drum 414.

Accordingly, when a foreign substance, such as paper in the case where the sheet S is a sheet of paper, adheres to the background member 36, the background member 36 can be cleaned. As a result, a false detection of the image sensor 34 caused by adhesion of the foreign substance to the background member 36 can be reduced.

In the electrophotographic printer 1000 and the inkjet printer 2000 according to the above-described embodiments of the present disclosure, the configuration is described in which an image is formed on a sheet S cut into a predetermined size in advance. However, the form of the medium is not limited thereto.

The form of the medium used for image formation may be, for example, a long continuous form such as continuous sheet or roll sheet.

A conveyance device according to an embodiment of the present disclosure is not limited to an inkjet printer for image formation but may be applied to an apparatus that discharges liquid for other purposes.

A description is given below of the conveyance device according to an embodiment of the present disclosure that discharges liquid for other purposes.

Electrode Manufacturing Apparatus

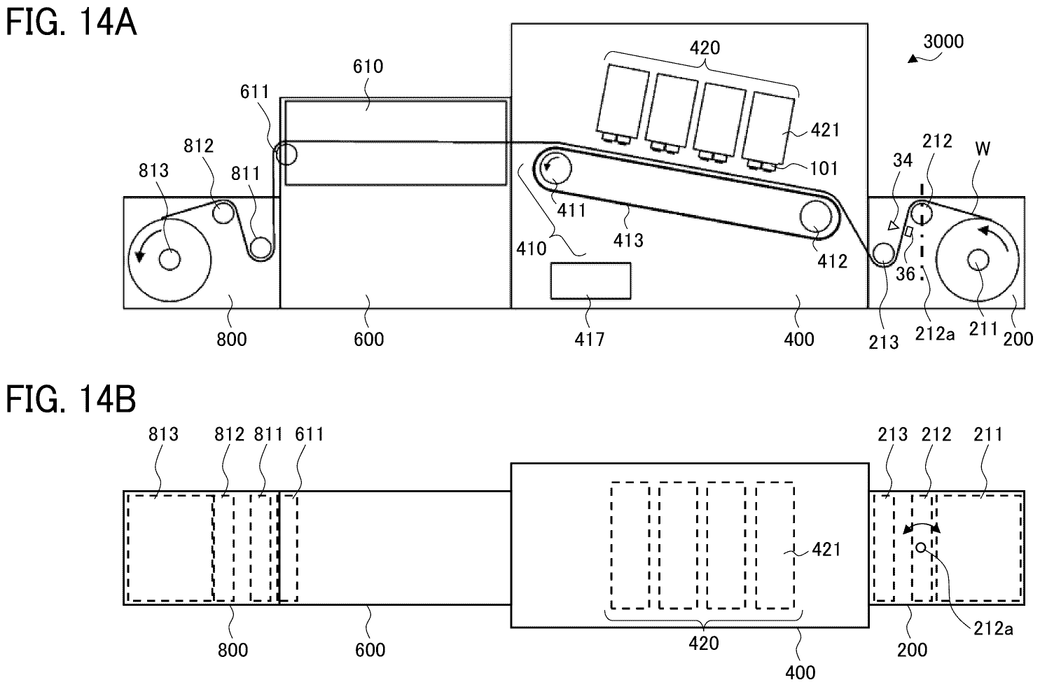

FIGS. 14A and 14B are diagrams each illustrating an overall configuration of a liquid discharge apparatus according to an embodiment of the present disclosure.

FIG. 14A is a schematic side view of the liquid discharge apparatus according to the present embodiment of the present disclosure and FIG. 14B is a schematic plan view of the liquid discharge apparatus of FIG. 14A.

The liquid discharge apparatus according to the present embodiment applies a liquid composition to a surface of a medium W to form a functional layer in order to manufacture an electrode included in an electrochemical element such as a primary battery, a secondary battery, or a capacitor.

An apparatus for manufacturing the electrode forms a resin layer or an inorganic layer on a surface of an electrode element that serves as the medium W by using, for example, liquid ink as ink for forming the resin layer or ink for forming the inorganic layer as the liquid composition.

In other words, the apparatus for manufacturing the electrode forms the resin layer or the inorganic layer on at least one of a surface of a metal foil and a surface of a mixture layer coated on the metal foil using the ink for forming the resin layer or the ink for forming the inorganic layer.

In the present embodiment, the electrode element is a target to which liquid ink is discharged in the apparatus for manufacturing an electrode. The electrode element is a precursor of an electrode formed by application of liquid ink.

As illustrated in FIGS. 14A and 14B, the electrode manufacturing apparatus 3000 includes a supply device 200, a printing device 400, a drying device 600, and an ejecting device 800.

The supply device 200 includes a support roller 211 that supports the medium W wound in a roll, guide rollers 212 and 213 that convey the medium W fed from the support roller 211 to the printing device 400, an image sensor 34, and a background member 36.

The supply device 200 serves as a conveyance device, and the guide roller 212 serves as a conveyor.

The medium W serves as a medium, and the image sensor 34 serves as a position sensor.

The guide roller 212 according to the present embodiment is a meandering correction roller that can rotate about an axis 212a that serves as a rotation fulcrum.

The image sensor 34 measures the position of the medium W conveyed by the guide rollers 212 and 213 in the main scanning direction (the width direction of the medium W intersecting the conveyance direction of the medium W).

When the medium W is conveyed at a position deviated from a reference position, the guide roller 212 is inclined in a direction to eliminate the deviation such that the medium W is aligned with the reference position.

The medium W is conveyed toward the printing device 400 while the above-described position correction is performed on the medium W.

The printing device 400 includes a conveyance unit 410 that conveys the medium W conveyed from the supply device 200 and an inkjet unit 420 that discharges ink onto the surface of the medium W conveyed by the conveyance unit 410.

The printing device 400 further includes a suction unit 417 that suctions air inside the printing device 400 to create a negative pressure inside the printing device 400.

The drying device 600 includes a drying furnace 610 and a guide roller 611. The drying furnace 610 dries ink on the surface of the medium W conveyed from the printing device 400. The guide roller 611 conveys the medium W sent from the drying furnace 610.

The drying furnace 610 has a function of heating ink on the surface of the medium W to dry residual solvent in the ink and a function of promoting curing of the ink.

The ejecting device 800 includes guide rollers 811 and 812 that convey the medium W sent from the drying device 600 and a winding roller 813 that winds the medium W sent from the guide roller 812.

In the printing device 400, the inkjet unit 420 includes multiple inkjet modules 421 along the conveyance direction of the medium W. Each of the inkjet modules 421 includes multiple heads 101 that discharge ink onto the surface of the medium W.

The head 101 serves as a liquid discharger.

The conveyance unit 410 includes a belt 413, a belt driving roller 411, and a belt driven roller 412. The belt 413 conveys the medium W, and is wound around and driven by the belt driving roller 411. The belt 413 is also stretched around the belt driven roller 412 to rotate together the belt driven roller 412.

Since the belt 413 is circularly conveyed by the rotation of the belt driving roller 411, the medium W is conveyed at substantially the same speed as the speed at which the belt 413 rotates.

The suction unit 417 creates a negative pressure inside the printing device 400 to generate an air flow in the printing device 400. Accordingly, floating of ink mist generated by ink discharge of the head 101 is reduced.

In the electrode manufacturing apparatus 3000 described above, an image sensor 34 according to an embodiment of the present disclosure may be disposed between the guide roller 212 and the guide roller 213.

Accordingly, when a foreign substance (metal powder dropped from the medium (electrode element) W or resin powder) adheres to the background member 36, the background member 36 can be cleaned. As a result, a false detection of the image sensor 34 caused by adhesion of the foreign substance to the background member 36 can be reduced.

Depending on the components of ink discharged from the head 101, the electrode manufacturing apparatus 3000 may be configured to include a curing unit (irradiation unit) between the printing device 400 and the drying device 600. The curing unit cures the ink layer on the surface of the medium W into the resin layer, using ultraviolet light.

Examples of such ink described above include an ink containing a polymerizable compound such as a monomer as a component.

In the electrode manufacturing apparatus 3000 described above, the configuration in which the liquid composition is applied to the medium W in a long continuous form is described by way of example, but the form of the medium is not limited thereto.

The form of a medium to be used may be, for example, a form of a sheet cut into a predetermined size in advance.

The electrode manufacturing apparatus 3000 according to the above-described embodiment of the present disclosure has a line type of apparatus configuration in which the medium W is conveyed with respect to the head 101 at a fixed position and ink is applied to the medium W. However, an electrode manufacturing apparatus according to an embodiment of the present disclosure is not limited to the line type.

As long as the head 101 and the medium W are configured to relatively move to each other, the electrode manufacturing apparatus may have any other configuration than the line type. For example, a serial type of apparatus configuration may be employed in which the head 101 is moved in a direction orthogonal to the conveyance direction of the medium W with respect to the medium W that is intermittently fed to apply ink to the medium W.

Alternatively, a flatbed type of apparatus configuration may be employed in which the head 101 is moved in the X and Y directions with respect to the medium held on a medium placing table to apply ink to the medium.

When the electrode manufacturing apparatus 3000 is used as a part of a power storage device manufacturing apparatus, the power storage device manufacturing apparatus includes, for example, a medium processing device that processes the medium W for cell formation, in addition to the electrode manufacturing apparatus 3000.

The medium processing device processes the medium W on which the functional layer is formed downstream from a liquid discharge head.

The medium processing device may perform at least one of cutting, folding, and adhesion.

For example, when the medium W is a continuous medium that is not cut, the medium processing device can cut the medium W to produce a medium laminate.

The medium processing device can wind or stack the medium W.

When an insulation layer includes a material having a melting point or a glass-transition point, in the medium processing device, for example, one medium laminate and the other medium laminate are at least partially adhered to each other by heating.

The medium processing device includes, for example, a medium processing unit to perform cutting of the medium W, zigzag folding of the medium W, lamination or winding, and thermal adhesion between the media after lamination or winding according to a target battery form.

When the medium is processed in the medium processing device, the conveyance speed of the medium W is preferably relatively low for the reason that a damage such as wrinkle can be reduced in the processed medium.

The step of processing a medium, which is performed by the medium processing device, is, for example, a step of processing the medium W, on which a function membrane has been formed, downstream from the liquid discharge head.

The step of processing a medium may include at least one of a cutting step, a folding step, and an adhesion step.

Supplementary Information on Embodiment

In the above-described embodiments of the present disclosure, the liquid discharge apparatus includes a liquid discharge head or a liquid discharge device, and drives the liquid discharge head to discharge liquid.

The liquid discharge apparatus according to the present embodiment may include an apparatus that can discharge liquid toward gas or into liquid in addition to an apparatus that can discharge liquid to a material to which liquid is adherable.

The liquid discharge apparatus may be, for example, a device that relates to the feeding, conveying, and discharging of a material to which liquid is adherable. Alternatively, the liquid discharge device may be, for example, a pre-processing device and a post-processing device.

The liquid discharge apparatus may be, for example, an image forming apparatus to form an image on a sheet by discharging ink, or a three-dimensional apparatus to discharge a molding liquid to a powder layer in which powder material is formed in layers, so as to form a three-dimensional article.

The liquid discharge apparatus is not limited to an apparatus to discharge liquid to visualize meaningful images, such as letters or figures.

For example, an apparatus that forms a meaningless pattern, or an apparatus that fabricates a three-dimensional image are also included.

The above-described term “material to which liquid is adherable” denotes, for example, a material or a medium to which liquid can adhere at least temporarily, a material or a medium to which liquid can attach and firmly adhere, or a material or a medium to which liquid can adhere and into which the liquid permeates.

Examples of the “material to which liquid is adherable” include recording media, such as sheet of paper, recording paper, recording sheet of paper, film, and cloth, electronic components, such as electronic substrate and piezoelectric element, and media, such as powder layer, organ model, and testing cell. The “material to which liquid is adherable” includes any material to which liquid is adhered, unless particularly limited.

The material of the above-described “material to which the liquid is adherable” is made of any material provided that liquid is adherable at least temporarily to the material. For example, the “material to which liquid is adherable” may include any materials on which liquid adheres even temporarily, such as paper, threads, fibers, fabric, leather, metal, plastic, glass, wood, ceramic a current collector such as aluminum foil or copper foil, or an electrode in which an active material layer is formed on a current collector.

The term “liquid” includes any liquid having a viscosity or a surface tension with which itself can be discharged from the head. However, preferably, the viscosity of the liquid is not greater than 30 millipascal-second (mPa·s) under normal temperature and normal atmospheric pressure or by heating or cooling.

More specifically, the liquid according to the present embodiment may be, for example, a solution, a suspension, or an emulsion that contains, for example, a solvent such as water or an organic solvent, a colorant such as dye or pigment, a functional material such as a polymerizable compound, a resin, or a surfactant, a biomaterial such as deoxyribonucleic acid (DNA), amino acid, protein, or calcium, an edible material such as a natural colorant, an active material and solid electrolyte used as electrode material, and ink containing conductive and insulative material.

These liquids can be used for, e.g., inkjet ink, surface treatment solution, a liquid for forming components of electronic element or light-emitting element or a resist pattern of electronic circuit, a material solution for three-dimensional fabrication, an electrode, or electrochemical element.

The liquid discharge apparatus may be an apparatus to relatively move the liquid discharge head and a material on which liquid can adhere. However, the liquid discharge apparatus is not limited to such an apparatus.

For example, the liquid discharge apparatus may include a printing device including a serial head device that moves the liquid discharge head or a line head device that does not move the liquid discharge head.

The liquid discharge apparatus according to the embodiments of the present disclosure may be, for example, a treatment liquid coating apparatus to discharge a treatment liquid to a sheet surface to coat the treatment liquid on the sheet surface to reform the sheet surface and an injection granulation apparatus in which a composition liquid including raw materials dispersed in a solution is injected through nozzles to granulate fine particles of the raw materials.

The above-described embodiments are given by way of example, and, for example, the following aspects of the present disclosure can provide the following advantages.

Aspect 1

A conveyance device (e.g., the sheet supply device 3) includes a conveyor (e.g., the pair of registration rollers 32 and 33), a position sensor (e.g., the image sensor 34), and a background member (e.g., the background member 36). The conveyor conveys a medium (e.g., the sheet S). The position sensor detects a position of the medium conveyed. The background member is disposed to face the position sensor. The background member is insertable and removable in a width direction of the medium crossing a conveyance direction of the medium.

Aspect 2

In the conveyance device described in Aspect 1, the conveyance device further includes a holder (e.g., holder 37) and an attachment base (e.g., the attachment base 38). The holder holds the background member (e.g., the background member 36). The holder is mounted on the attachment base such that the holder is insertable and removable in the width direction of the medium.

Aspect 3

In the conveyance device described in Aspect 2, the attachment base (e.g., the attachment base 38) includes a first restraint (e.g., the sidewalls 38c and 38d) that restricts the position of the holder (e.g., holder 37) in the conveyance direction of the medium.

Aspect 4

In the conveyance device described in Aspect 2 or Aspect 3, the attachment base (e.g., the attachment base 38) includes a second restraint (e.g., the pressing members 38a and 38b) that restricts the position of the holder (e.g., holder 37) in the width direction of the medium.

Aspect 5

In the conveyance device described in Aspect 4, the second restraint (e.g., the pressing members 38a and 38b) includes an elastic member. The holder (e.g., holder 37) includes a positioner (e.g., the positioning member 37b) to contact the elastic member to restrict the position of the holder in the width direction of the medium.

Aspect 6

In the conveyance device described in Aspect 5, the positioner (e.g., the positioning member 37b) includes a slope (e.g., the slope 371) and a recess (e.g., the recess 372) to act on the elastic member (e.g., the pressing members 38a and 38b). The height of the recess is lower than the highest point of the slope and is substantially the same as the height of a contact surface of the elastic member when the holder (e.g., holder 37) is attached to the attachment base (e.g., the attachment base 38).

Aspect 7

In the conveyance device described in any one of Aspects 1 to 6, the conveyor (e.g., the pair of registration rollers 32 and 33) is configured to move the medium (e.g., the sheet S) in the width direction of the medium.

Aspect 8

In the conveyance device described in any one of Aspects 1 to 7, the conveyance device includes an attaching sensor (e.g., the attaching sensor 39) that detects whether the holder (e.g., holder 37) is attached to the attachment base (e.g., the attachment base 38).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A conveyance device comprising:
a conveyor configured to convey a medium;
a position sensor to detect a position of the medium conveyed by the conveyor; and
a background member facing the position sensor,
the background member insertable and removable in a width direction of the medium crossing a conveyance direction of the medium.

2. The conveyance device according to claim 1, further comprising:
a holder holding the background member; and
an attachment base on which the holder is attached such that the holder is insertable to and removable from the attachment base in the width direction of the medium.

3. The conveyance device according to claim 2,
wherein the attachment base includes a restraint that restricts a position of the holder in the conveyance direction of the medium.

4. The conveyance device according to claim 2,
wherein the attachment base includes a restraint that restricts a position of the holder in the width direction of the medium.

5. The conveyance device according to claim 4,
wherein the restraint includes an elastic member, and
wherein the holder includes a positioner to contact the restraint to restrict the position of the holder in the width direction of the medium.

6. The conveyance device according to claim 5,
wherein the positioner includes a slope and a recess to act on the restraint, and
wherein a height of the recess is lower than a highest point of the slope and is same as a height of a contact surface of the restraint when the holder is attached on the attachment base.

7. The conveyance device according to claim 1,
wherein the conveyor is configured to move the medium in the width direction of the medium.

8. The conveyance device according to claim 2, further comprising an attaching sensor to detect whether the holder is attached on the attachment base.

9. An image forming apparatus comprising:
the conveyance device according to claim 1; and
an image forming device configured to form an image on the medium conveyed by the conveyance device.

10. The image forming apparatus according to claim 9, further comprising
a secondary transfer device,
wherein the position sensor is disposed upstream from the secondary transfer device in the conveyance direction of the medium.

11. A liquid discharge apparatus comprising:
the conveyance device according to claim 1; and
a liquid discharger configured to discharge liquid to the medium conveyed by the conveyance device.
